(19) United States
(12) Patent Application Publication
(10) Pub. No.: US 2004/0117471 A1
(43) Pub. Date: Jun. 17, 2004

(54) Consultation service/support system, consultation service terminal, and server

(75) Inventor: Kazutaka Nakamura, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/703,432

(22) Filed: Nov. 10, 2003

(30) Foreign Application Priority Data
Nov. 12, 2002 (JP) 328739/2002

(51) Int. Cl. G06F 15/173

(52) U.S. Cl. 709/223

(57) ABSTRACT

In recent years, the content of consultation services in various fields has become more sophisticated, and hence it is sometimes impossible for a single counselor to respond sufficiently. As a result, it may be impossible for a consultation service to proceed smoothly. In a consultation service/support system according to the present invention, a consultation service terminal for performing a consultation service with a customer is connected to a consultation service support terminal which supports the consultation service with the customer by outputting data for supplementing the content of a past or present display image on the consultation service terminal, and the consultation service terminal is provided with two displays.

### BACKGROUND OF THE INVENTION

1. Field of the Invention

The present invention relates to a system and related equipment for performing a consultation service with a customer smoothly by displaying to the customer appropriate screens for the consultation subject of the customer.

2. Description of Related Art

Conventional terminal devices (to be referred to as “consultation service terminals” below) exist for performing a consultation service with a customer smoothly by displaying to the customer appropriate screens for the consultation subject of the customer while the customer and a counselor on a service provider side converse. A window device (see, for example, paragraphs 0002 to 0004 and FIG. 19 of Japanese Unexamined Patent Application Publication 2001-112595) used in financial institutions such as a bank or consumer credit facility, transportation systems such as railroads and the aviation industry, distribution facilities such as supermarkets and department stores, and so on exists as one type of consultation service terminal.

A window device is a consultative interactive device disposed in the window of a bank or railroad, for example, and used to provide various services (for example, opening an account, creating a loan contract, and so on in a bank, or selling tickets and the like on a railroad) while a counselor on the service provider side interacts directly with the customer.

A conventional consultation service terminal is constituted such that one counselor can respond to one customer or one group of customers.

In recent years, however, the content of services in various fields has become more sophisticated, and hence when a conventional consultation service terminal is used, a single counselor may not be able to respond sufficiently.

In the banking industry, for example, the content of a money loaning operation which is typically performed in a bank (for example, the type of loan and loan conditions, the amount, interest, method of repayment, contractual conditions, and so on) has diversified to the extent that normal commercial banks have begun to provide fiduciary services. Moreover, services which are not typically provided by a bank, such as insurance, securities transactions, and so on have come to be provided. In order to accommodate this increased sophistication in service content, counselors are required to obtain a high level of knowledge and experience. In order for each counselor to gain a high level of knowledge and experience, however, high-level education programs must be provided to the counselors and a large amount of time must be invested. Moreover, there are limitations on and variations in the knowledge and experience that each counselor is able to gain. As a result, a single counselor may not be able to sufficiently respond to the consultation needs of a customer.

Hence a problem arises in conventional consultation service terminals in that smooth consultation services sometimes cannot be implemented.

Further, window devices, which are a type of conventional consultation service terminal, are not constituted such that a customer and counselor can view the same display unit. As a result, misunderstandings sometimes arise between the customer and counselor. In response, a window device in which the display unit is disposed between the customer and counselor such that both the customer and counselor can see the same display unit has been proposed.

However, since the counselor and customer both view the same display unit in this type of window device, data that the counselor wishes to conceal from the customer (to be referred to as “confidential data” below) cannot be displayed. As a result, the counselor is unable to perform consultation services while referring to confidential data.

Hence regarding this point also, a conventional consultation service terminal is sometimes unable to implement smooth consultation services.

### SUMMARY OF THE INVENTION

An object of the present invention is to provide a consultation service/support system which enables smooth consultation services to be implemented at all times, and which is capable of displaying data to be concealed from a customer.

A consultation service/support system according to the present invention comprises a consultation service terminal for performing a consultation service with a customer by displaying on a display appropriate screens for the consultation subject of the customer, and a consultation service support terminal for supporting the consultation service with the customer by outputting data for assisting the consultation service with the customer. Further, the display of the consultation service terminal comprises a customer display, which is disposed so as to be viewable from the customer side and a counselor side, for displaying screens to be provided to the customer, and a counselor display, which is disposed so as to be viewable from the counselor side but not from the customer side, for displaying screens to be concealed from the customer.

According to the consultation service/support system constituted in this manner, the consultation service support terminal outputs the data for assisting the consultation-service with the customer that is being conducted on the consultation service terminal to an external device (for example, a server or consultation service terminal), whereupon the consultation service terminal receives these data and displays the data on the display. Hence in cases where a counselor is unable to respond sufficiently to the consultation subject of the customer or the like, the counselor who is operating the consultation service terminal can obtain from the operator of the consultation service support terminal data which correspond precisely to the consultation subject of the customer. Moreover, the consultation service terminal displays confidential data on a display that cannot be seen from the customer side. Hence the counselor can conduct the consultation service while referring to the confidential data. Note that the confidential data comprise the results of a customer analysis performed by a computer (for example, customer creditworthiness, account balance, the type of service to be provided to the customer, and so on), data inputted by the counselor (for example, favorable or unfavorable impressions of the customer, messages from a previous counselor to a following counselor, and so on), and other data. The data for assisting the consultation service with the customer are also a type of confidential data.

### BRIEF DESCRIPTION OF THE DRAWINGS

The foregoings and other objects, features and advantages of the present invention will be better understood from the following description taken in connection with the accompanying drawings, in which:

FIG. 1 is a view showing the constitution of a consultation service/support system according to the present invention;

FIG. 2 is a view showing examples of the functions of each server;

FIG. 3 is a view showing the constitution of a consultation service terminal;

FIG. 4 is a view showing the constitution of a consultation service support terminal;

FIG. 5 is a view showing the constitution of the main parts of the terminal;

FIG. 6 is a view showing examples of the functions of the terminal;

FIG. 7 is a view showing an example of a virtual screen;

FIG. 8 is a flowchart showing an operation of the system;

FIG. 9 is a view showing an example of an initial screen on a customer display unit;

FIG. 10 is a view showing an example of an initial screen on a counselor display unit;

FIG. 11 is a view showing an example of a channel screen;

FIG. 12 is a view showing an example of a screen on the counselor display unit;

FIG. 13 is a view showing an example of a screen on the counselor display unit;

FIG. 14 is a view showing an example of a screen on the counselor display unit;

FIG. 15 is a view showing an example of an initial screen on the consultation service support terminal;

FIG. 16 is a view showing an example of a screen on the consultation service support terminal;

FIG. 17 is a view showing an example of a screen on the customer display unit;

FIG. 18 is a view showing an example of a screen on the counselor display unit;

FIG. 19 is a view showing an example of a screen on the counselor display unit;

FIG. 20 is a view showing an example of screen disposal; and

FIG. 21 is a flowchart showing an example of shared server control.

### DESCRIPTION OF THE PREFERRED EMBODIMENTS

An embodiment of the present invention will be described below with reference to the drawings. Note that in each drawing, the form, magnitude, and positional relationships of each constitutional component are merely illustrated schematically in order to facilitate understanding of the present invention. Further, common elements in each drawing have been allocated identical reference symbols, and duplicate description thereof has been omitted. Note that in the following description, the service provider is a bank. Further, the operator of the consultation service terminal will be referred to as a counselor, and the operator of the consultation service support terminal will be referred to as a supporter.

[System Constitution]

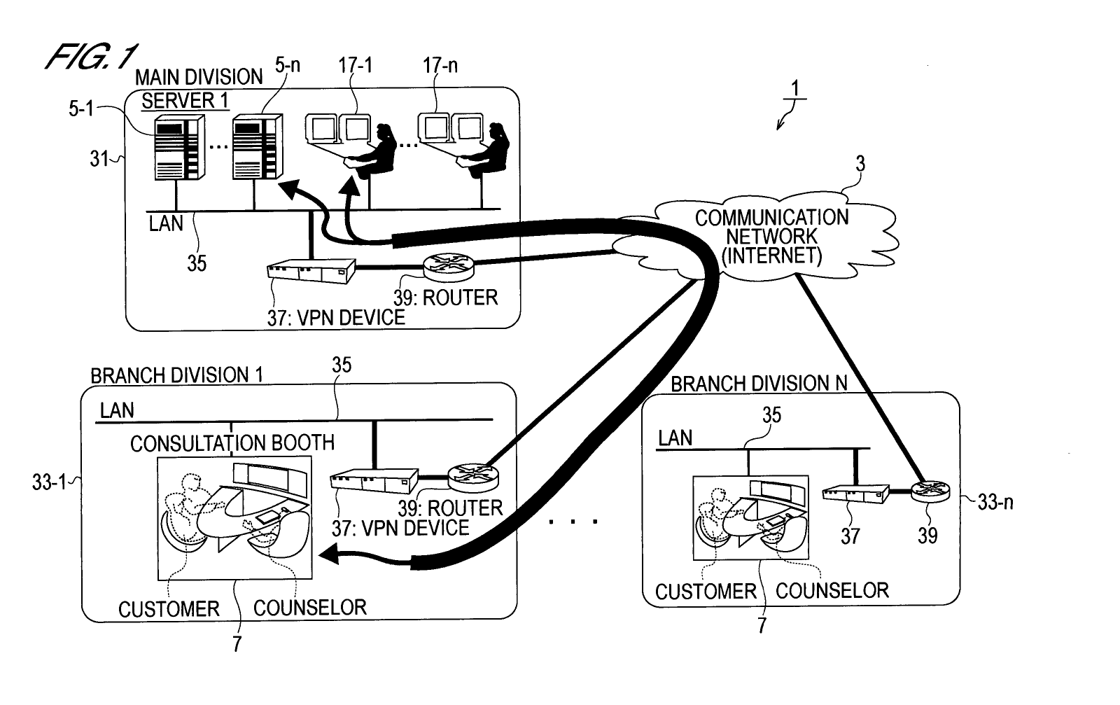

FIG. 1 is a view showing the constitution of a consultation service/support system according to the present invention.

As shown in FIG. 1, a consultation service/support system 1 is constituted by a server 5 connected via a communication network 3, a consultation service terminal 7 for performing consultation services with a customer, a consultation service support terminal 17 for supporting the consultation service, and so on. The consultation service terminal 7 and consultation service support terminal 17 are capable of operating a shared application to be described hereinafter which is stored on a shared server, also to be described hereinafter. Note that the consultation service terminal 7 and consultation service support terminal 17 will be referred to together as “the terminals” below.

The structural equipment of the consultation service/support system 1 is normally divided between a main division 31 and branch divisions 33-1 to 33-n. The structural equipment on the main division 31 side comprises servers 5-1 to 5-n, consultation service support terminals 17-1 to 17-n, and so on, for example. The structural equipment on the side of the branch divisions 33-1 to 33-n comprises the consultation service terminal 7 and other terminals not shown in the drawing, for example. Note that in the example shown in FIG. 1, only one main division 31 is provided, but a plurality may be provided. Also in the example shown in FIG. 1, only one consultation service terminal 7 is provided for each of the branch divisions 33-1 to 33-n, but in reality, a desired number of consultation service terminals 7 would be disposed in each of the branch divisions 33-1 to 33-n.

The structural equipment of the main division 31 and the structural equipment of each of the branch divisions 33-1 to 33-n are connected through internetworking devices such as a virtual private network device (VPN device) 37 and a router 39, and through the communication network 3 such as the Internet. Note that the VPN device 37 is a connection device for protecting communication security. During communication, the VPN device 37 connects specific terminals after identifying the terminals, and thus prevents another terminal from interrupting the connection between the specified terminals. The router 39 is a connection device comprising a relay function for delivering IP packets to a destination host. In recent years, routers having a VPN function have come into existence, and hence the VPN device 37 and router 39 may be integrated.

In this consultation service/support system 1, the communication network 3 is a broadband network capable of communicating images. The communication network 3 may be a public network such as an Internet network or wireless communication network, but is preferably a private network such as a wide local area network (wide area LAN).

The servers 5-1 to 5-n comprise various functions to be described below, and execute various calculations. One or a plurality of the servers 5-1 to 5-n stores a shared application program (to be referred to as “shared application” below) to be described below which can be operated by both of the terminals (consultation service terminal 7, consultation service support terminal 17), and the shared application is executed on the basis of an operation by the terminals. An image resulting from this execution is then displayed on the terminals. Note that the server which stores and executes the shared application will be referred to below as the “shared server”. In the following description, the server 5-1 will be described as the shared server.

The consultation service/support system 1 is connected to external equipment (for example, a group of external computers, a group of computers of business associates, and so on). Hence the equipment of the consultation service/support system 1 can obtain various information from the external computer group, business associate computer group, and soon. In particular, when the consultation service/support system 1 is connected to a group of business associate computers, the group of business associate computers can serve as consultation service support terminals, and the business associates themselves can serve as supporters of the consultation service. Hence a consultation service with a high level of expertise can be provided. Note that the business associate may be an individual or an organization.

(Functional Constitution of the Servers

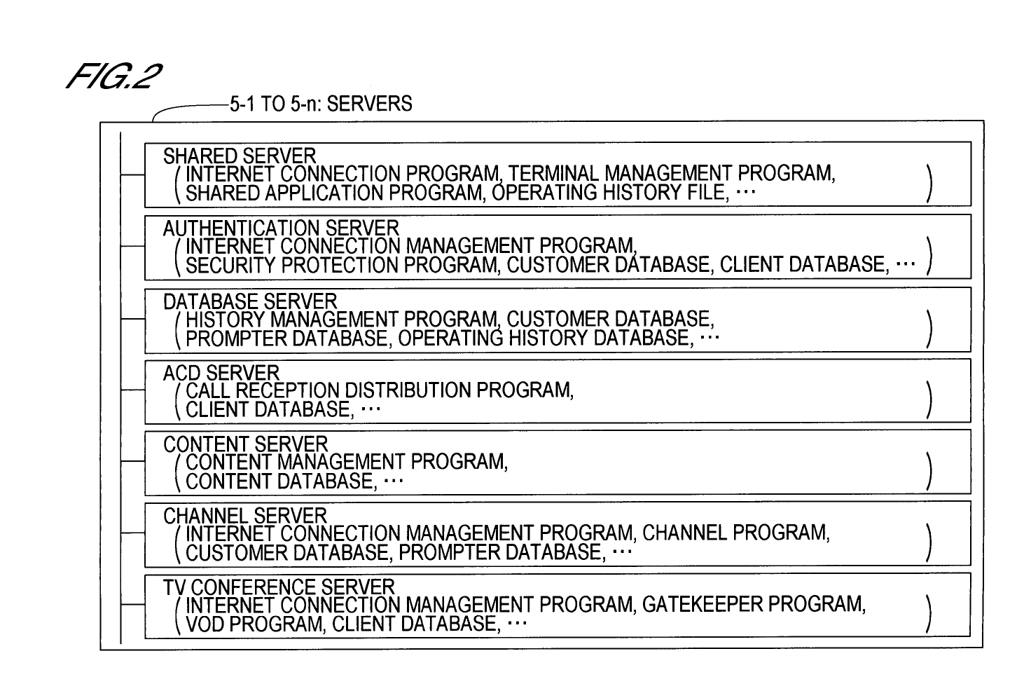

The functional constitution of the servers will be described below using FIG. 2.

FIG. 2 shows an example of the main functions of each of the servers 5-1 to 5-n disposed in the main division 31. Each of the servers 5-1 to 5-n executes one or a plurality of the functions shown in FIG. 2. Note that a constitution in which one server executes all of the functions is possible, but in this case description will be provided assuming that each server 5-1 to 5-n executes one function.

A first main function is a shared server function. Functioning as the shared server signifies storing the shared application and executing the shared application on the basis of an operation from the terminals. In order to realize such a function, the shared server stores an Internet connection program, a terminal management program, the shared application, an operating history file, and so on, for example, as shown in FIG. 2. Here, the Internet connection program is a program for executing communication with the outside via the Internet. The terminal management program is a program for managing operating control rights to be described below and the terminals which possess these rights. The shared application is an application that can be operated by both the consultation service terminal 7 and the consultation service support terminal 17, and which creates a virtual screen to be described below on the basis of an operation from the consultation service terminal 7 or consultation service support terminal 17. The operating history file is a file for recording the history of operations from the consultation service terminal 7 or consultation service support terminal 17 during the implementation of consultation services.

The shared server is capable of controlling input by the counselor and supporter and controlling image display. During the control of input from the counselor and supporter in particular, the shared server enables data transmission and reception and image display in a chat format (a format enabling alphanumerical communication between people in remote locations). During image display control, annotations can be displayed, customer images 8A, 18A can be displayed on a customer display unit 7A of the consultation service terminal 7 or a first display unit 17A of the consultation service support terminal 17, and counselor images 8B, 18B can be displayed on a counselor display unit 7B of the consultation service terminal 7 or a second display unit 17B of the consultation service support terminal 17. Further, any image or document can be obtained from a contents server, and the customer images 8A, 18A or counselor images 8B, 18B can be displayed in accordance with the sequence of an explanation. The shared server is also capable of causing a printer not shown in the drawing but provided in the consultation service terminal 7 to perform printing in response to a printing instruction according to an operation of the consultation service support terminal 17.

A second main function is an authentication server function. Functioning as the authentication server entails specifying a terminal, person, or the like through which communication is to be performed, and authenticating the terminal or person. In order to realize this function, the authentication server stores an Internet connection management program, a security protection program, a customer database (to be referred to as “customer DB” below), a client database (to be referred to as “client DB” below), and so on, for example, as shown in FIG. 2. Here, the Internet connection management program is a program for managing connections between equipment and preventing infection of the system by a virus during communication between the equipment in the system via the Internet. The security protection program is a program for managing the authority of operators and terminals to access data having a set security level. The customer database (to be referred to as “customer DB” below) is a database for recording and managing data relating to customers. The client database (to be referred to as “client DB” below) is a database of recording and managing data relating to the operator of each terminal.

A third main function is a database server (to be referred to as “DB server” below) function. Functioning as the DB server entails storing and managing data relating to customers, prompter data to be described below for specifying images to be displayed on the display units, terminal operating histories, and so on. In order to realize such a function, the DB server stores a history management program, the aforementioned customer DB, a prompter database, an operating history database (to be referred to as “operating history DB” below), and so on, for example, as shown in FIG. 2. Here, the history management program is a program for creating a virtual screen to be described below on the basis of the operating history recorded in the operating history DB. The prompter data base is a data base for recording and managing prompter data to be described below. The operating history DB is a database for recording an operating history outputted from the shared server.

A fourth main function is an automatic call distributor (to be referred to as “ACD” below) server function. Functioning as the ACD server means appropriately allocating a call-making side terminal to a call-receiving terminal during communication between terminals, and thereby controlling/managing inter-terminal connections. In order to realize this function, the ACD server stores a call reception distribution program, the aforementioned client DB, and so on, for example, as shown in FIG. 2. Here, the call reception distribution program is a program for allocating a call-making side terminal to a call-receiving side terminal. Note that the allocated call-making side terminal and call-receiving side terminal are connected after being identified by the VPN device 37. The ACD server holds communication control rights even after the call-making side terminal and call-receiving side terminal have been connected, and hence controls the communication between the call-making side terminal and call-receiving side terminal. However, control rights may be transferred to the VPN device 37 after the call-making side terminal and call-receiving side terminal are connected such that communication control between the call-making side terminal and call-receiving side terminal is performed by the VPN device 37. In this case, communication between the call-making side terminal and call-receiving side terminal is performed without passing through the ACD server, and hence communication can be performed smoothly with little time-lag.

A fifth main function is a content server function. Functioning as the content server means storing various images created in accordance with the consultation service, and providing these images to a server when various applications are executed on the server. In order to realize this function, the content server stores a content management program, a content database (to be referred to as “content DB” below), and so on, for example, as shown in FIG. 2. Here, the content DB is a database for recording and managing images of various types of content, and the content management program is a program which, when predetermined content has been read out from the shared server, DB server, or the like, outputs images of corresponding content from the content DB to the shared server, DB server, or the like.

A sixth main function is a channel server function. Functioning as the channel server means storing the results of a customer analysis performed by a computer (for example, customer creditworthiness, account balance, the type of service to be provided to the customer, and so on), data inputted by a counselor (for example, favorable or unfavorable impressions of the customer, messages from a previous counselor to a following counselor, and so on), and other data, and providing these data (to be referred to as “channel data” below) to a server when various applications are executed on the server. In order to realize this function, the channel server stores the aforementioned Internet connection management program, a channel program, the aforementioned customer DB and prompter DB, and so on, for example, as shown in FIG. 2. Here, the channel program is a program for creating images on a screen used for displaying channel data (to be referred to as “channel screen” below). Note that data which are preferably to be concealed from the customer in particular, such as the channel data presented here or data for assisting a consultation service with a customer that are outputted from the consultation service support terminal to the consultation service terminal in the chat format to be described below or by another method, will be referred to as “confidential data”.

A seventh main function is a TV conference server function. Functioning as the TV conference server entails executing a TV conference by transceiving between terminals images and audio obtained through a camera and microphone not shown in the drawings. In order to realize this function, the TV conference server stores the aforementioned Internet connection management program, a gatekeeper program, a video-on-demand program (to be referred to as “VOD program” below), the aforementioned client DB, and so on, for example, as shown in FIG. 2. Here, the gatekeeper program is a program for preventing another terminal from interrupting communication between terminals. The VOD program is a program for distributing moving images or still images recorded in advance in the TV conference server and DB server to a specific terminal.

Note that in the following description, the server 5-1, server 5-2, server 5-3, server 5-4, server 5-5, server 5-6, and server 5-7 refer to the shared server, authentication server, DB server, ACD server, content server, channel server, and TV conference server respectively.

(Constitution of Terminal)

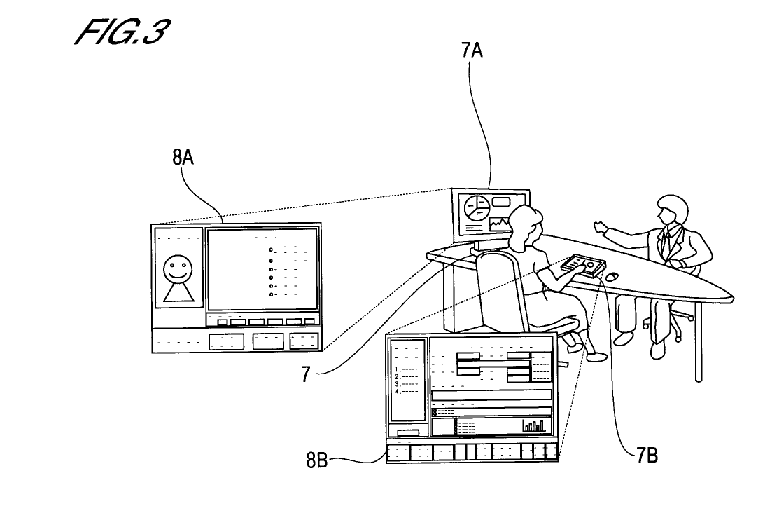

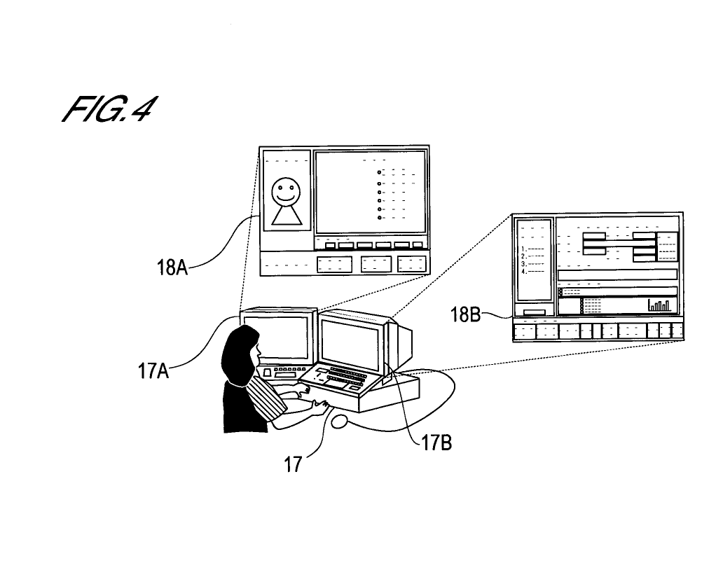

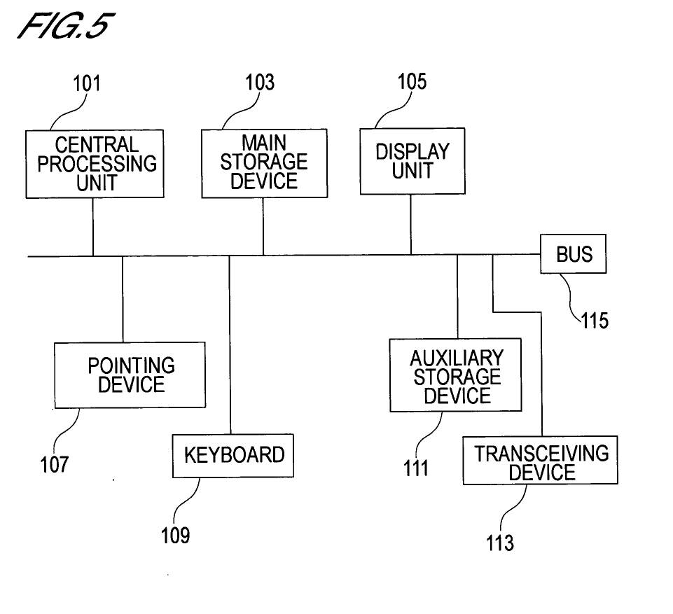

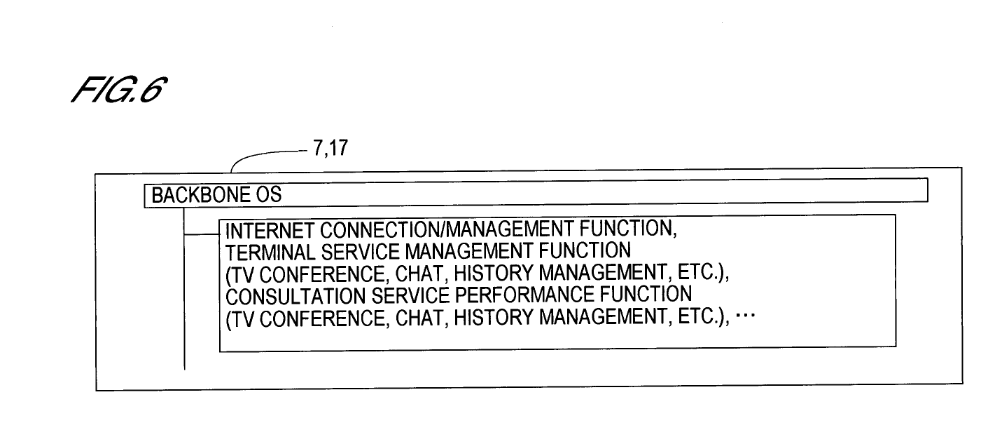

The constitution of the terminals will now be described using FIGS. 3 to 5. Note that FIG. 3 is a view showing the constitution of a consultation service terminal, and FIG. 4 is a view showing the constitution of a consultation service support terminal. FIG. 5 is a view showing the constitution of the main parts of the terminals, and FIG. 6 is a view showing examples of the functions of the terminals.

As shown in FIG. 3, the consultation service terminal 7 is constituted by a computer comprising the display unit (to be referred to as “customer display unit” below) 7A for displaying appropriate images for the consultation subject of the customer, and the display unit (to be referred to as “counselor display unit” below) 7B for displaying images to be used by the counselor.

The consultation service terminal 7 is disposed such that the customer display unit 7A can be viewed from the customer side and counselor side, and such that the counselor display unit 7B can be viewed from the counselor side but not from the customer side, with the customer chair and counselor chair placed on opposite sides of a table such that the customer and counselor face one another. The consultation service terminal 7 also comprises a TV camera, microphone, speakers, and so on not shown in the drawing. Note that the counselor display unit 7B shown in FIG. 3 is a touch panel combining a display function and an input function, but the input function may be provided as a separate device (for example a keyboard, pen input device, or similar).

As shown in FIG. 4, the consultation service support terminal 17 is constituted by a computer. To be capable of supporting consultation services, the consultation service support terminal 17 comprises a function for displaying the same images as the images displayed on the consultation service terminal 7, and a function for outputting data for assisting the consultation service with the customer.

Since the consultation service terminal 7 comprises two display units, the consultation service support terminal 17 preferably comprises two display units corresponding thereto. For example, the consultation service support terminal 17 shown in FIG. 4 comprises a first display unit 17A corresponding to the customer display unit 7A of the consultation service terminal 7, and a second display unit 17B corresponding to the counselor display unit 7B of the consultation service terminal 7. An identical image 18A to the image 8A (or an image comprising a part of the image 8A), which is displayed on the customer display unit 7A, is displayed on the first display unit 17A, and an identical image 18B to the image 8B (or an image comprising a part of the image 8B), which is displayed on the counselor display unit 7B, is displayed on the second display unit 17B.

As shown in FIG. 5, the main parts of these terminals comprise a central processing unit (CPU) 101, a main storage device 103, a display unit 105, a pointing device 107, a keyboard 109, an auxiliary storage device 111, a transceiving device 113, and a bus 115. The central processing unit 101 controls each part via the bus 115, and displays various images on the display unit 105 (for example, a CRT, liquid crystal display, or similar) on the basis of input from the pointing device 107 (for example, a mouse or the like) and keyboard 109. The main storage device 103 is random access memory (RAM) or the like, and stores various data and programs. The auxiliary storage device 111 is a hard disk drive or the like, and stores various data and programs. The transceiving device 113 is a modem, LAN board, or similar.

Further, as shown in FIG. 6, these terminals comprise an Internet connection and management function, a terminal service management function, a consultation service performance function, and so on. Here, the Internet connection and management function is a function for executing an operation of the shared application or obtaining images and documents of various content by making a connection with the shared server 5-1, the external computer group, the associate computer group, and so on. The terminal service management function is a function for making a connection with the consultation service support terminal 17 or another terminal and managing operating control rights to be described below in cooperation with the shared server in order to execute a TV conference, transmission and reception of alphanumeric data in a chat format, history management, and soon. The consultation service performance function is a function for displaying various screens suited to the consultation subject of the customer, and executing a TV conference, transmission and reception of alphanumeric data in a chat format, history management, and so on in order to perform a consultation service. The consultation service terminal 7 stores various programs and data for realizing these functions.

[System Operations]

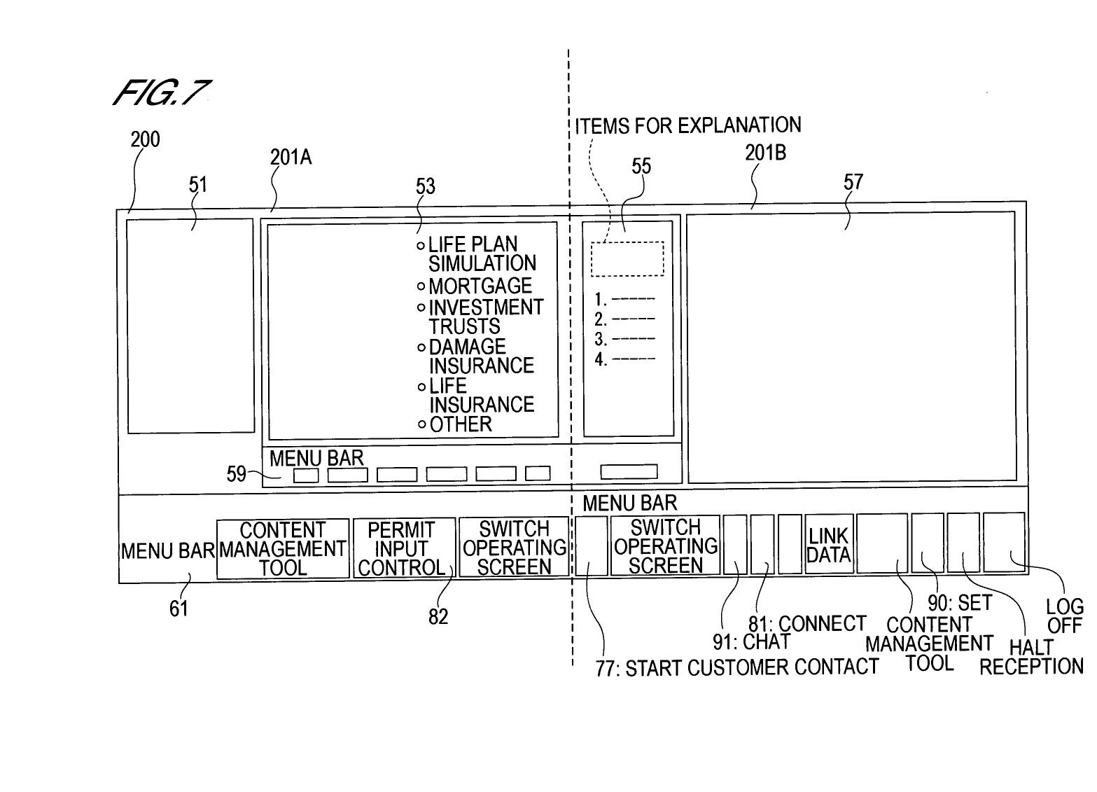

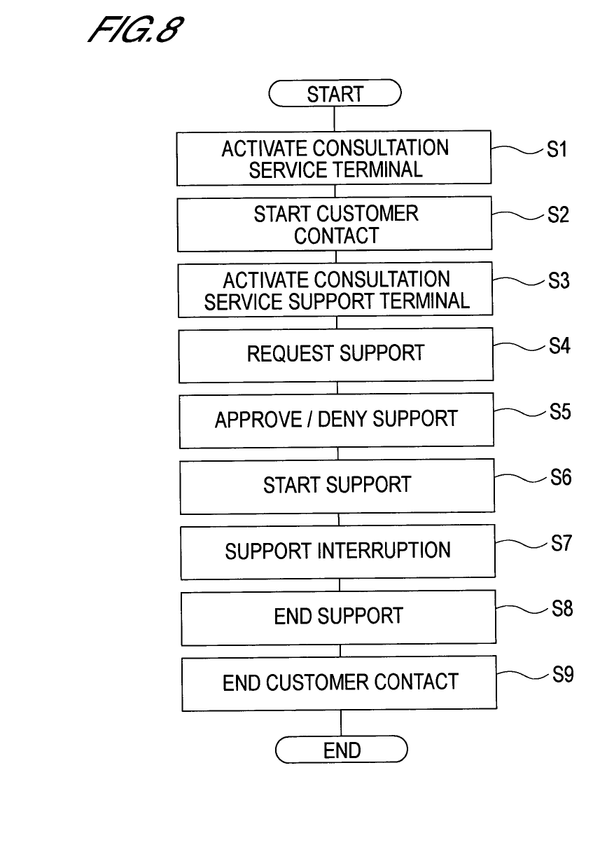

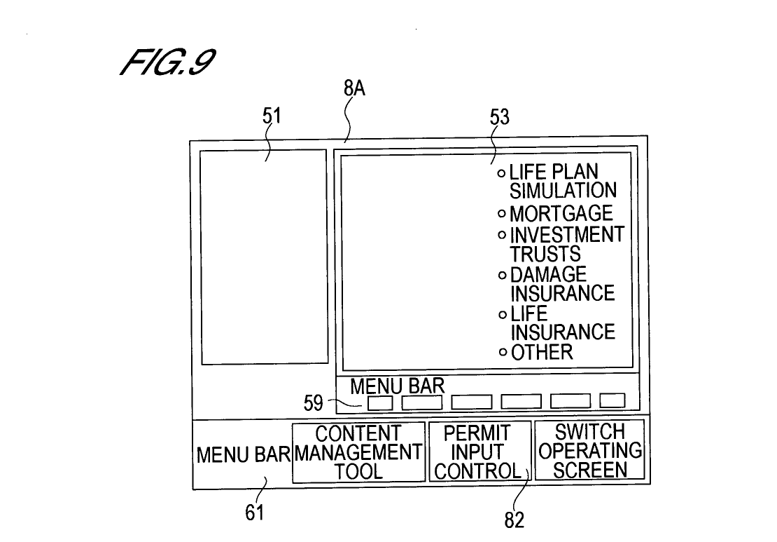

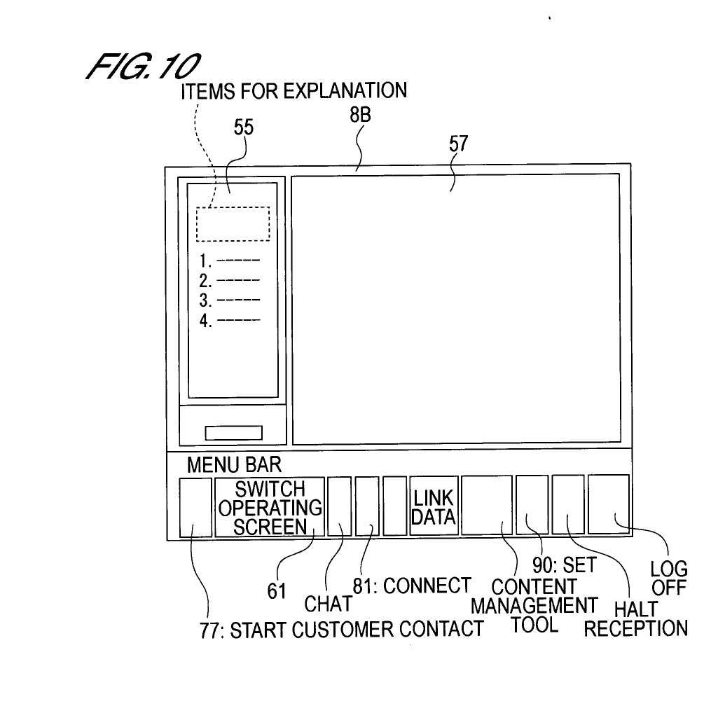

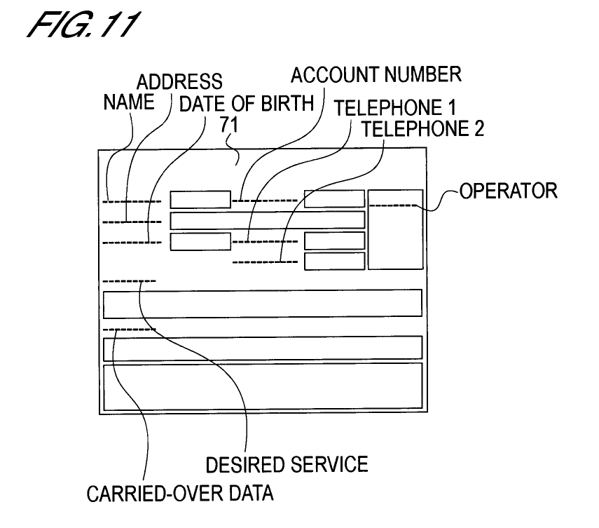

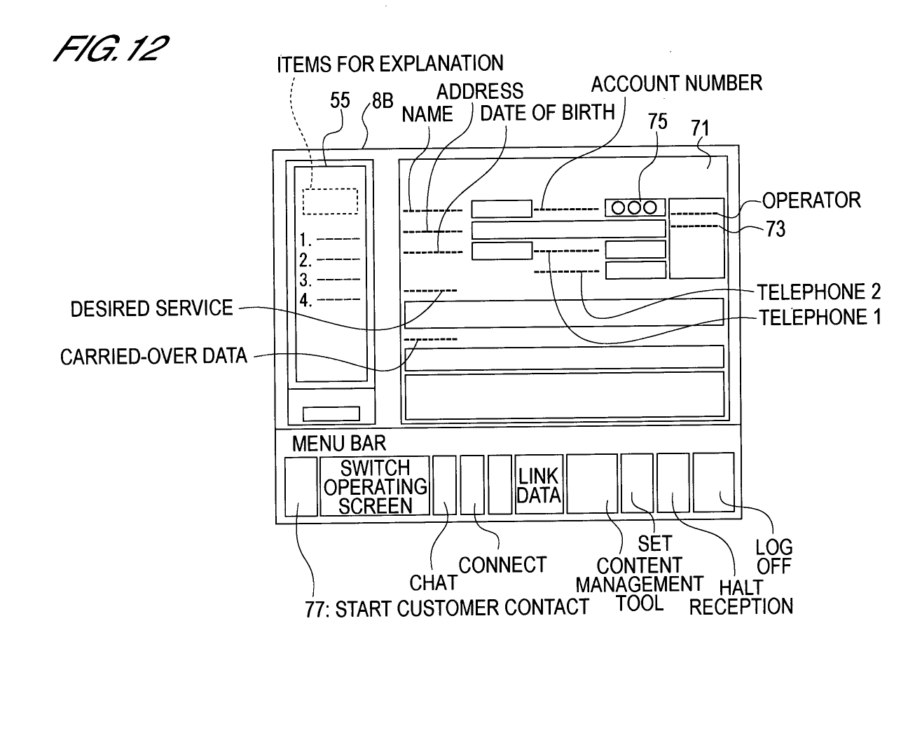

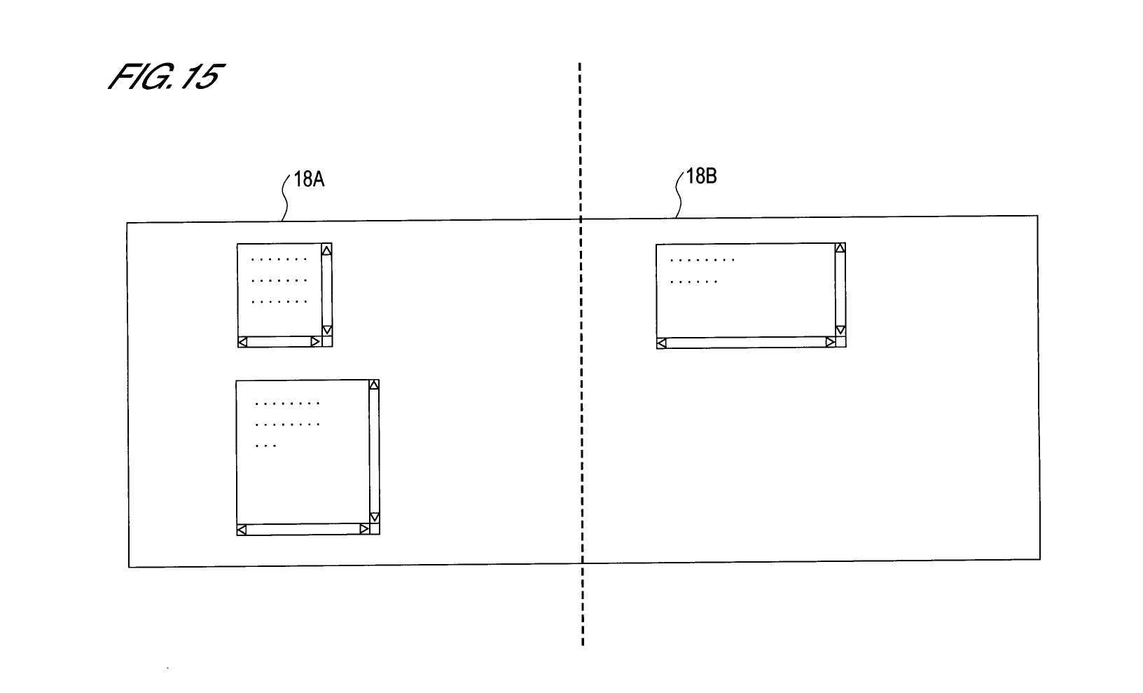

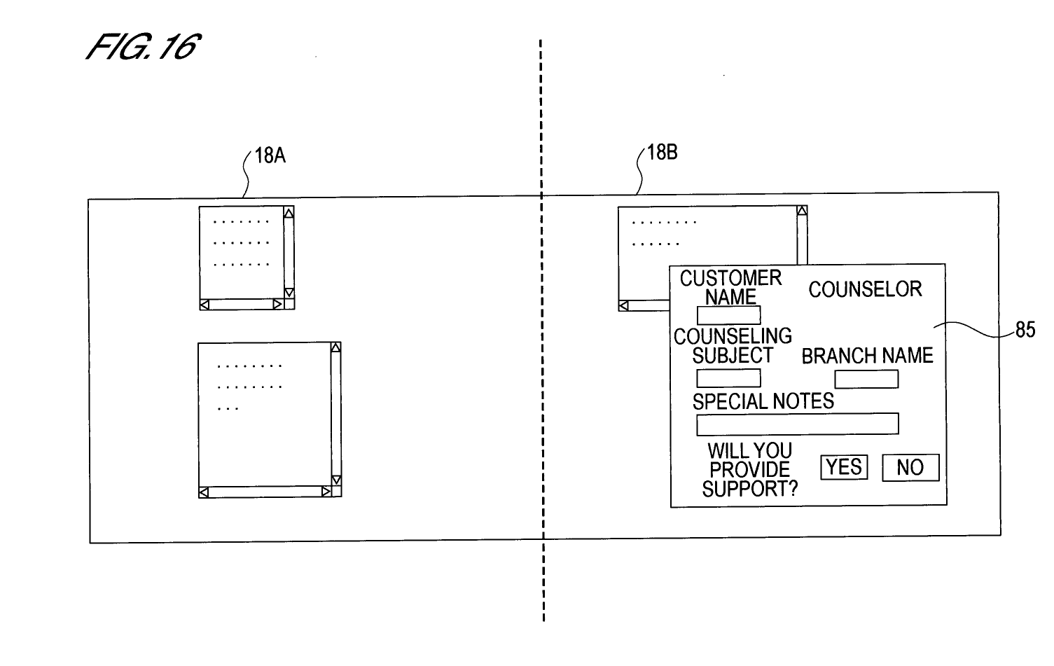

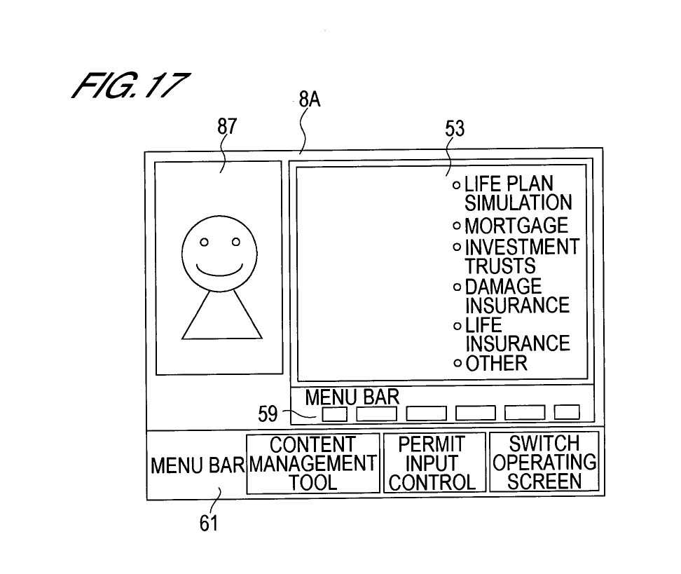

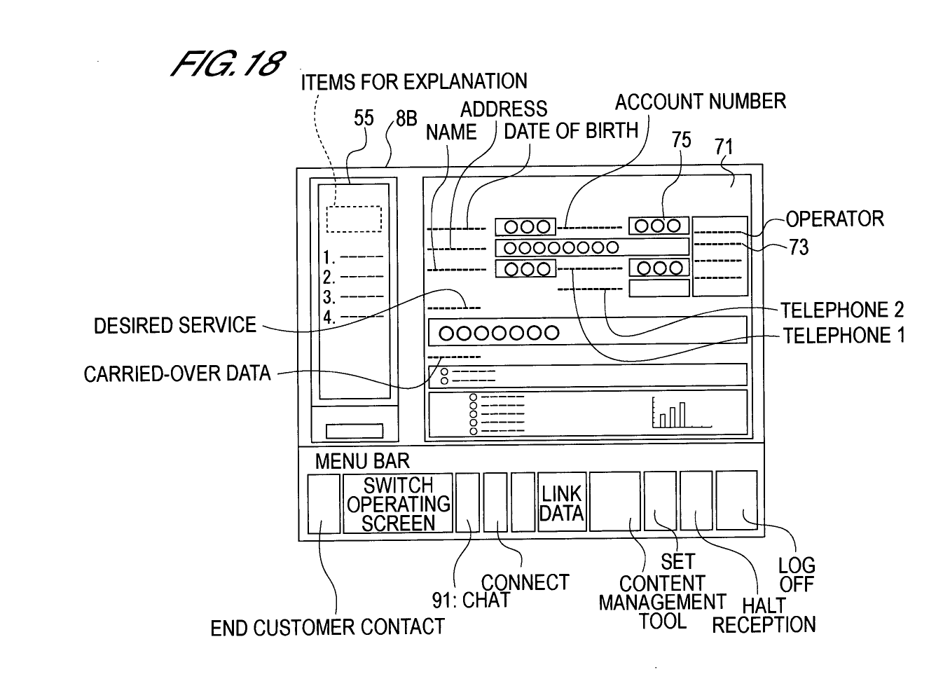

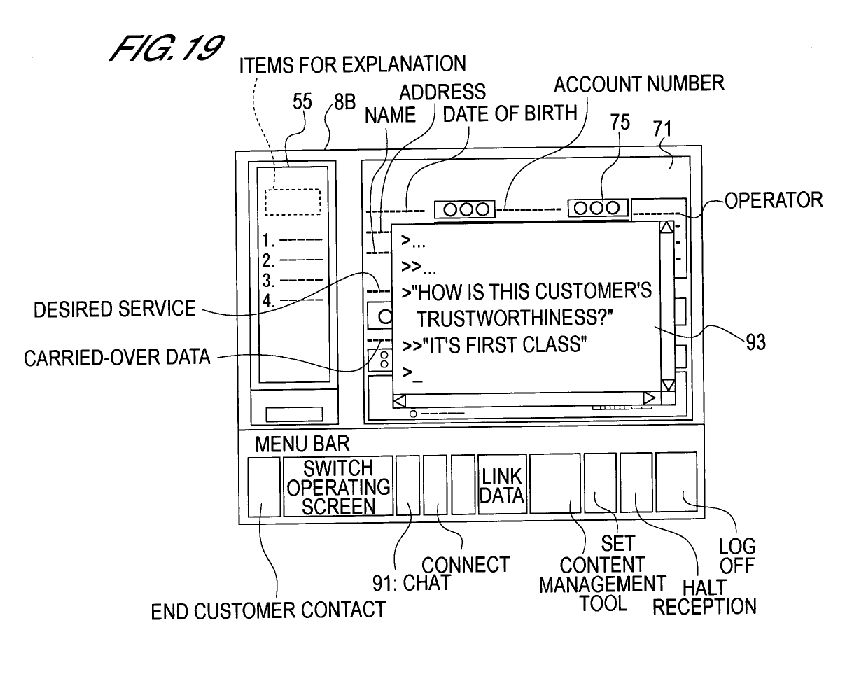

An operation of the system will now be described using FIGS. 7 through 19. Note that below, a virtual screen which forms the basis of a system operation will be described using FIG. 7, an outline of a system operation will be described using FIG. 8, and a system operation will be described in detail using FIGS. 9 through 19 by describing examples of the screens that are displayed on the terminals. Note that FIG. 7 is a view showing an example of the virtual screen, FIG. 8 is a flowchart showing a system operation, FIG. 9 is a view showing an example of an initial screen on the customer display unit, FIG. 10 is a view showing an example of an initial screen on the counselor display unit, FIG. 11 is a view showing an example of a channel screen, FIGS. 12 to 14 are views showing examples of screens on the counselor display unit, FIG. 15 is a view showing an example of an initial screen on the consultation service support terminal, FIG. 16 is a view showing an example of a screen on the consultation service support terminal, FIG. 17 is a view showing an example of a screen on the customer display unit, and FIGS. 18 and 19 are views showing examples of screens on the counselor display unit.

(Virtual Screen)

As described above, the shared server 5-1 executes the shared application on the basis of an operation from the terminals (the consultation service terminal 7 and consultation service support terminal 17), and creates a virtual screen image showing the results of this execution. FIG. 7 shows an example of an image on the virtual screen. Note that the virtual screen image may be subjected to various modifications in accordance with the intended application, specifications, and so on.

As shown in FIG. 7, an image on a virtual screen 200 comprises regions 51, 53, 55, 57, 59, 61, and so on, for example. Here, the region 51 is a region in which a television conference image 87 to be described below is displayed during a television conference. The region 53 is a region in which images to be referred to by the customer and counselor (for example, a screen image corresponding to the assumed consultation subject of the customer (to be referred to as a “consultation subject screen” below), an image showing the results of an execution of the shared application, and so on) are displayed. The region 55 is a region in which explanation sequences, key points and so on required to perform the consultation are displayed. The region 57 is a region in which a screen image for displaying channel data created by the channel server 5-6 (to be referred to as a “channel screen” below) is displayed. The regions 59, 61 are both regions for displaying various menu bars used to operate the shared application or another application. Note that selectable items or menu bars may also be provided in the regions 53, 55, 57. When a selectable item or menu bar is depressed, images or applications linked thereto are displayed or executed.

The image on the virtual screen 200 is stored in the content server 5-5, for example, divided into an image which forms the background part of an image 201A on the left side of the broken line in FIG. 7 and an image which forms the background part of an image 201B on the right side of the broken line. The images incorporated into the regions 53, 55, 57, and so on within the image 201A and image 201B are also stored in the content server 5-5, channel server 5-6, and so on. The shared server 5-1 stores prompter data for specifying a combination of the background part image of the image 201A, the background part image of the image 201B, and the images incorporated into the regions 53, 55, 57, and so on. The images specified by the prompter data are retrieved from the content server 5-5 and channel server 5-6 and synthesized. Thus the shared server 5-1 creates the image on the virtual screen 200 shown in FIG. 7.

The constitution of the prompter data is as follows, for example: <process number, URL of background part image of image 201A, URL of background part image of image 201B, URL of image incorporated into region 53, URL of image incorporated into region 55, . . . >. On the basis of the prompter data, the shared server 5-1 retrieves the background part image of the image 201A, the background part image of the image 201B, and the images incorporated into the regions 53, 55, 57, and so on from the content server 5-5 and channel server 5-6, and synthesizes these images.

The constitution of the prompter data may be subjected to various modifications other than the constitution described above. For example, the following constitution is possible: <process number, title of background part image of image 201A, title of background part image of image 201B, title of image incorporated into region 53, title of image incorporated into region 55, . . . >.

The image on the virtual screen 200 created by the shared server 5-1 is displayed on the terminals, but at this time, the terminals display the image divided into a customer image (that is, an image to be viewed by the customer) and a counselor image (that is, an image to be viewed by the counselor and concealed from the customer). In the example shown in FIG. 7, the image 201A in the region on the left side of the broken line is the customer image, and the image 201B in the region on the right side of the broken line is the counselor image. For example, the consultation service terminal 7 divides the image on the virtual screen 200 into the images 201A and 201B, whereby the image 201A is displayed on the customer display unit 7A as the customer image 8A shown in FIG. 9, and the image 201B is displayed on the counselor display unit 7B as the counselor image 8B shown in FIG. 10. Since the consultation service terminal 7 is disposed such that the counselor display unit 7B can be viewed from the counselor side but not from the customer side, the counselor is thus able to perform the consultation service while showing the customer appropriate data for the consultation subject of the customer and referring to confidential data.

Although not shown in FIG. 7, an arrow for specifying an input location is displayed in a predetermined position on the actual image. This arrow may be moved around the screens of the two display units (the customer display unit 7A and counselor display unit 7B in the case of the consultation service terminal 7, and the first display unit 17A and second display unit 17B in the case of the consultation service support terminal 17) by an operation of the pointing device of the terminal (for example, a mouse or the like), not shown in the drawing, performed by the counselor or supporter. When the counselor manipulates the arrow, various operations (for example, selecting a selectable item displayed on both of the screens, inputting data into a predetermined column displayed on both of the screens, altering the display position of an image displayed on both screens (for example, an image displayed in the regions 53, 55, 57, 59, 61, and so on) or the size of a region, and so on) can be performed.

(Outline of a System Operation)

As noted above, an outline of a system operation will now be described using FIG. 8. Note that here, description is provided on the premise that each of the servers 5-1 to 5-n is activated.

As shown in FIG. 8, the consultation service/support system 1 is operated according to the following sequence, for example: activation of the consultation service terminal 7 (step (to be referred to as “S” below) 1), beginning of customer contact (S2), activation of the consultation service support terminal 17 (S3), request for support (S4), approval/denial of support (S5), beginning of support (S6), interruption of support (S7), end of support (S8), end of customer contact (S9).

Each of these steps will be described in detail in the following section (“Detailed Description of a System Operation”) using examples of screens displayed on the terminals shown in FIGS. 9 through 19.

(Detailed Description of a System Operation)

(Activation of Consultation Service Terminal—S1)

When activated, the consultation service terminal 7 logs onto the shared server 5-1, whereby a connection with the shared server 5-1 begins. At this time, the authentication server 5-2 identifies the consultation service terminal 7. When the consultation service terminal 7 is a correct pre-registered terminal, the authentication server 5-2 performs authentication and the result thereof is notified to the shared server 5-1. As a result, the shared server 5-1 permits a connection with the consultation service terminal 7 to be made. When the consultation service terminal 7 is an improper unregistered terminal, the authentication server 5-2 does not perform authentication, and the shared server 5-1 does not permit a connection to be made with the consultation service terminal 7.

When the shared server 5-1 and the consultation service terminal 7 connect, the image on the virtual screen 200 shown in FIG. 7 is created as described above and outputted to the consultation service terminal 7. As described above, the consultation service terminal 7 divides the image on the virtual screen 200 into the image 201A and the image 201B, whereupon the image 201A is displayed on the customer display unit 7A and the image 201B is displayed on the counselor display unit 7B. FIGS. 9 and 10 show examples of the images displayed on the customer display unit 7A and counselor display unit 7B respectively at this time. Note that the shared server 5-1 may create the image on the virtual screen 200 prior to connection with the consultation service terminal 7.

(Beginning of Customer Contact—S2) Next, it is assumed that a customer visits the bank in order to discuss a loan application or the like. To begin a consultation with the customer, the counselor presses a customer contact start bar 77 shown in FIGS. 7 and 10. Note that the customer contact start bar 77 is a menu bar indicating the beginning of a consultation with a customer. At this time, the ACD server 5-4 (or the authentication server 5-2 or DB server 5-3) updates the data in the database for managing the consultation service terminal 7 from “unconnected” to “activated”, and then from “activated” to “in contact”. In so doing, the consultation service terminal 7 can be caused to execute the shared application stored in the shared server 5-1. The shared application is executed by inputting data into various data input columns displayed within the image on the virtual screen 200 created by the shared server 5-1, by depressing the menu bars 59, 61 shown in FIG. 7, or by a similar method.

When the aforementioned customer contact start bar 77 is depressed, the consultation service terminal 7 begins a consultation service with the customer. The counselor then presses an item corresponding to the consultation subject of the customer from among the selectable items displayed within the region 53 in FIG. 9, for example.

Then, the shared server 5-1 retrieves an image 71 shown in FIG. 11 from the channel server 5-6, and incorporates the image 71 into the region 57 of the virtual screen 200. Note that the image 71 is a screen image for displaying the aforementioned channel data (in other words, the aforementioned channel screen). The image 71 maybe modified in accordance with the consultation subject of the customer. The shared server 5-1 outputs the image on the virtual screen 200 with the image 71 incorporated into the region 57 to the consultation service terminal 7. As a result, the consultation service terminal 7 displays the image shown in FIG. 12, or in other words an image with the image 71 incorporated into the region 57, on the counselor display unit 7B.

Next, the counselor inputs a personal code into a region 73 for inputting an operator code, inputs data for specifying the customer, such as an account number, for example, and then presses the customer contact start bar 77. Note that the data for specifying the customer may comprise name, date of birth, telephone number, and so on, but preferably comprise an account number since an account number enables the customer to be specified as one person.

Next, the shared server 5-1 outputs the counselor code inputted into the region 73 to the authentication server 5-2. The authentication server 5-2 compares the counselor code inputted into the region 73 to data stored in a database, and outputs data indicating the operations that may be executed in accordance with the counselor code to the shared server 5-1. Thus, if the content of the operation performed by the counselor is included in the permitted operations, the shared server 5-1 performs calculations based on the operation, and if the content of the operation performed by the counselor is not included in the permitted operations, the shared server 5-1 halts the calculations based on the operation. It is assumed here that the content of the operation performed by the counselor is a permitted operation.

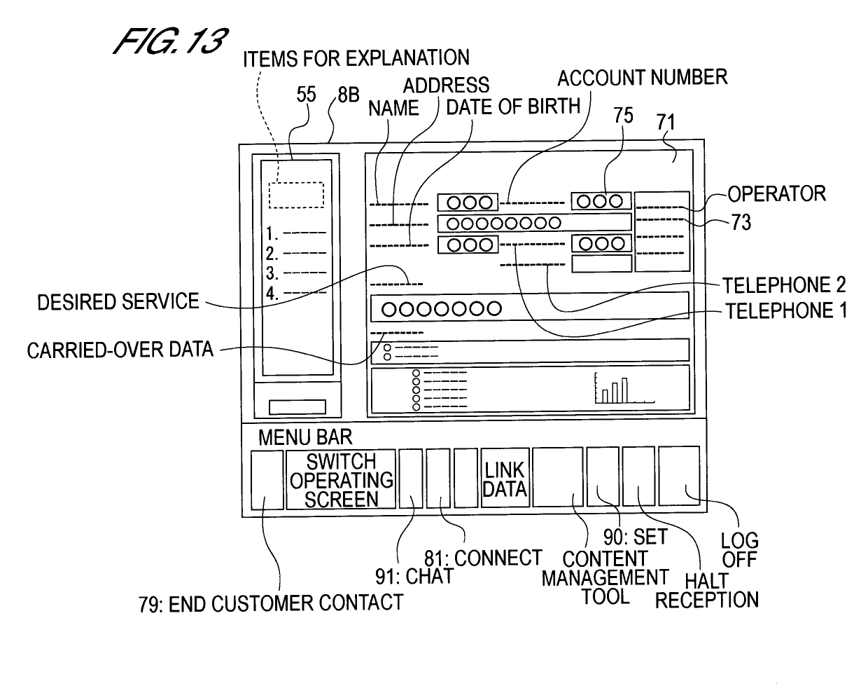

Next, the shared server 5-1 retrieves customer channel data from the channel server 5-6 on the basis of the data specifying the customer, and then creates the image shown in FIG. 13. The created image shown in FIG. 13 is then outputted to the consultation service terminal 7. Thus the consultation service terminal 7 displays the image shown in FIG. 13 on the counselor display unit 7B. The counselor conducts a consultation with the customer while viewing the image shown in FIG. 13. At this time, if there are any data to be recorded as channel data, the counselor inputs such data into a predetermined location on the image shown in FIG. 13. Note that in the image shown in FIG. 13, a customer contact end bar 79 for instructing the completion of the consultation with the customer is provided in place of the customer contact start bar 77.

Every time the shared server 5-1 executes the shared application in accordance with an operation of the consultation service terminal 7 or consultation service support terminal 17 (for example, whenever the image on the virtual screen 200 is modified or the disposal position or content of the images in the regions 51, 53, 55, 57, 59, 61, and so on within the virtual screen is modified), an operating history is recorded temporarily in the operating history file of the shared server 5-1 in accordance with the aforementioned prompter data format, for example. In so doing, real-time history display, to be described below, becomes possible. When customer contact ends, the operating history temporarily recorded in the operating history file of the shared server 5-1 is outputted to the DB server 5-3 and stored therein. In so doing, past history display, to be described below, becomes possible. Operations performed when the shared server 5-1 records an operating history will be described below.

It is assumed, for example, that the counselor has modified the customer channel data. At this time, the shared server 5-1 outputs the image displayed in the region 57 of the counselor display unit 7B (in other words, the screen images displaying channel data shown in FIGS. 11 to 14 (to be referred to as a “channel image” below) 71) to the channel server 5-6. In response, the channel server 5-6 stores the channel image 71 obtained from the shared server 5-1, and outputs data (for example, a URL, address, image title, or the like) specifying the region in which the channel image 71 has been stored to the shared server 5-1. Note that below, the data specifying the region in which the channel image 71 has been stored will be referred to as channel image storage data. The shared server 5-1 then stores this in the following format, for example: <process number, URL of background part image of image 201A, URL of background part image of image 201B, URL of image incorporated into region 53, URL of image incorporated into region 55, display region of channel image 71, channel server ID, channel image storage data, . . . >. Thus the shared server 5-1 records the operating history of the consultation service terminal 7 and consultation service support terminal 17. Note that when the consultation with the customer ends, the operating history is outputted to the DB server 5-3 and recorded by the DB server 5-3 as table data (to be referred to as an “operating history table” below). The operating history table will be described below in the section (Operating history management method) within the section [Usage form and management method of operating history].

(Activation of Consultation Service Support Terminal—S3)

Next, when activated, the consultation service support terminal 17 logs onto the ACD server 5-4. At this time, the consultation service support terminal 17 is not yet connected to the shared server 5-1 or consultation service terminal 7, and is on standby. The ACD server 5-4 (or the authentication server 5-2 or DB server 5-3) then updates the data in the database for managing the consultation service support terminal 17 from “unconnected” to “on standby”. Note that the consultation service/support system 1 is preferably constituted such that during a consultation with a customer, the consultation service support terminal 17 and consultation service terminal 7 cannot be connected from the consultation service support terminal 17 side. In so doing, a third party can be prevented from interrupting a consultation with a customer against the wishes of the counselor, and thus the counselor can focus exclusively on conversing with the customer. Malfunctions in the shared server 5-1, consultation service terminal 7, and peripheral equipment thereof can also be prevented. Further, since no unnecessary connections are made, increases in communication traffic can be prevented, whereby the system can be maintained in a favorable communication condition, and a situation in which no consultation service support terminals 17 are available for connection when a request for support is placed can be prevented.

(Request for Support—S4)

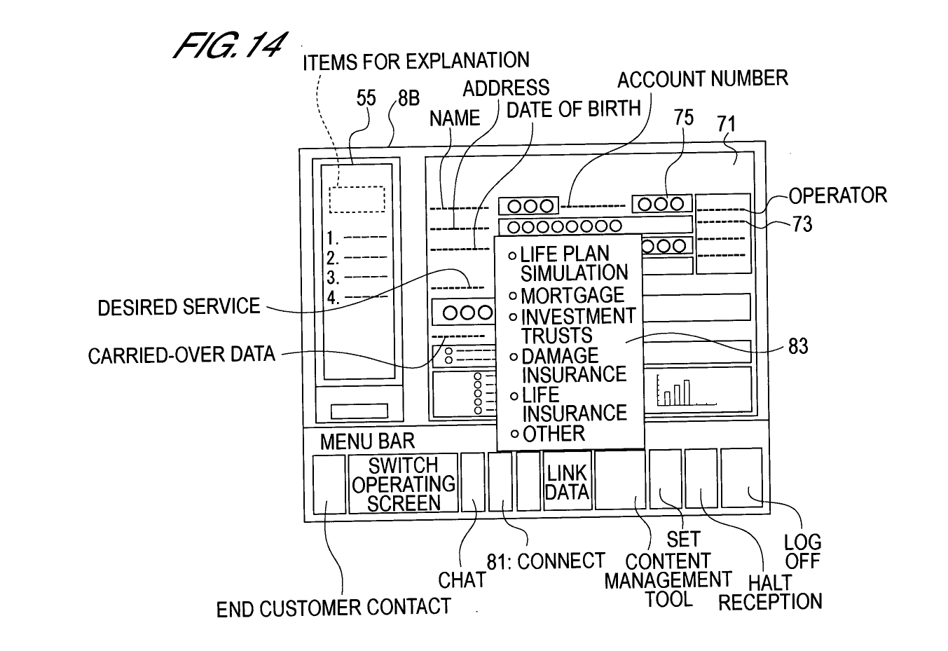

Next, it is assumed that during the consultation with the customer, a situation arises in which support is requested of a supporter. At this time, the counselor presses a connection bar 81 shown in FIG. 13, for example, and then presses a corresponding consultation subject item from among the selectable items shown in FIG. 14, which are displayed in response to depression of the connection bar 81. Note that the connection bar 81 is a menu bar indicating connection with the consultation service support terminal 17. On the basis of this operation, the shared server 5-1 outputs data indicating the support request source from which the connection bar 81 was pressed (for example, the ID of the consultation service terminal 7, the consultation subject classification, the name of the customer, the name of the counselor, and so on) to the ACD server 5-4. The ACD server 5-4 then selects a terminal from among the plurality of consultation service support terminals 17-1 to 17-n which can currently be connected, and which is being operated by a supporter who is capable of dealing most appropriately with the consultation subject. The VPN device 37 then connects the consultation service terminal 7 on which the connection bar 81 was pressed to the consultation service support terminal 17 selected by the ACD server 5-4.

At the time of initialization, the consultation service support terminal 17 displays the image shown in FIG. 15, for example. In FIG. 15, the image 18A in the region on the left side of the broken line is the image which is displayed on the first display unit 17A, and the image 18B in the region on the right side of the broken line is the image which is displayed on the second display unit 17B. FIG. 15 shows a state in which a window displaying a program has been opened on the background screen.

Having been selected by the ACD server 5-4, the consultation service support terminal 17 obtains the support request source data outputted from the ACD server 5-4. Then, as shown in FIG. 16, for example, the consultation service support terminal 17 displays an image 85 showing the support request source data on the first display unit 17A or second display unit 17B. Note that the support request source data comprise the consultation subject classification, the name of the customer, the name of the counselor, messages from a previous counselor to the following counselor, and so on, for example. The service provider may select one or a plurality of items there from and set these items as support request source data. Also, in this case the support request source data are outputted from the ACD server 5-4, but may be outputted from another server.

(Approval/denial of Support—S5)

The consultation service support terminal 17 is capable of approving or denying a request for support.

When a request for support is approved by the consultation service support terminal 17, for example, the supporter presses a key displayed as “YES” within the image 85, as a result of which a signal indicating support approval is outputted to the ACD server 5-4. Having received the signal indicating support approval, the ACD server 5-4 outputs data specifying the consultation service support terminal 17 which approved the support (the ID of the consultation service support terminal 17 or the like) to the shared server 5-1. The shared server 5-1 outputs an image indicating the results of the current execution of the shared application (that is, the image on the virtual screen 200) to the consultation service support terminal 17 which approved the support. At this time, the shared server 5-1 outputs the image displayed on the customer display unit 7A of the consultation service terminal 7 to the consultation service support terminal 17 as an image to be displayed on the first display unit 17A, and outputs the image displayed on the counselor display unit 7B of the consultation service terminal 7 to the consultation service support terminal 17 as an image to be displayed on the second display unit 17B. Hence the consultation service support terminal 17 displays the same images as the images displayed on the consultation service terminal 7 at this time. Note that the consultation service support terminal 17 may be constituted to be capable of operations such as expanding or compressing the displayed image 18A or 18B. In this case, however, only the size of the image expanded into an image depiction memory, not shown in the drawing, in the interior of the consultation service support terminal 17 is altered, and the shared application is not executed. Hence the image on the virtual screen 200 created by the shared server 5-1 does not change, and the image 8A or image 8B displayed on the consultation service terminal 7 does not change.

When a request for support is denied by the consultation service support terminal 17, the supporter presses a key displayed as “NO” within the image 85, as a result of which a signal indicating support denial is outputted to the ACD server 5-4. Having received the signal indicating support denial, the ACD server 5-4 repeats the process to search for a consultation service support terminal 17 which is capable of providing support until a consultation service support terminal 17 which approves the support is found.

Hence the consultation service support terminal 17 is capable of approving or denying a request for support from the consultation service terminal 7. When the support is approved, the consultation service support terminal 17 is capable of displaying an image indicating the results of an execution of the shared application according to an operation of the consultation service terminal 7, and thus the supporter operating the consultation service support terminal 17 can grasp the content of the consultation with the customer, and can thereby provide support to the consultation service.

(Beginning of Support—S6)

When the key displayed as “YES” on the image 85 is pressed by the supporter, the shared server 5-1 outputs the image currently displayed on the consultation service terminal 7 (in other words, the image on the virtual screen 200) to the selected consultation service support terminal 17. As a result, the consultation service support terminal 17 displays an identical image to the image currently displayed on the consultation service terminal 7. FIG. 17 is an example of the image displayed on the customer display unit 7A of the consultation service terminal 7 at this time. An example of the image displayed on the counselor display unit 7B of the consultation service terminal 7 at this time is shown in FIG. 13. Note that when a TV conference image 87 within FIG. 17 is displayed on the consultation service terminal 7, the image shows the face of the supporter, but when displayed on the consultation service support terminal 17, the image shows the face of the customer or counselor. The consultation service support terminal 17 in its initial state (that is, when an input control permission bar 82 has not been pressed) does not possess control rights for operating the shared application of the shared server 5-1 (to be referred to as “operating control rights” below), and is only capable of displaying the image on the virtual screen 200 and severing the connection by pressing the connection bar 81. Note that the shared server 5-1 performs control such that operating control rights cannot be provided to the consultation service support terminal 17 by an operation on the consultation service support terminal 17 side.

Next, in order to provide operating control rights to the consultation service support terminal 17, the counselor presses the input control permission bar 82. As a result, the consultation service support terminal 17 becomes able to operate the shared application.

The supporter supports the consultation with the customer by operating the shared application from the consultation service support terminal 17. At this time, support by the supporter is performed through conversation in a chat format or television conference format, execution of an operation of the shared application from the consultation service support terminal 17, and so on, for example.

Support through conversation in a chat format is performed when the counselor depresses a chat bar 91 shown in FIG. 18, for example. At this time, the shared server 5-1 creates the image shown in FIG. 19 (that is, an image combining the image shown in FIG. 18 with a chat window 93), and outputs this image to the consultation service terminal 7 and consultation service support terminal 17. As a result, the consultation service terminal 7 displays the image shown in FIG. 19 on the counselor display unit 7B, and the consultation service support terminal 17 displays the image shown in FIG. 19 on the second display unit 17B. Hence the counselor and supporter may hold a conversation in a chat format. Support in a chat format may be performed such that the conversation between the counselor and supporter is concealed from the customer, and is therefore favorable in cases where the content of the conversation is to be concealed from the customer. Support through conversation in a chat format may also be performed using dictionary data prepared in advance. In this case, for example, the supporter operates the consultation service support terminal 17 such that dictionary data stored on a recording medium (such as a floppy (registered trademark) disk or CD-ROM, for example) or on the hard disk device of the consultation service support terminal 17 are expanded onto the second display unit 17B. The supporter then copies desired data from the expanded dictionary data and pastes the data onto the chat screen 93. In this manner, support using dictionary data prepared in advance is performed.

Support through conversation in a television conference format is performed when the counselor presses the input control permission bar 82, for example. At this time, the consultation service terminal 7 and consultation service support terminal 17 capture the image 87 using a camera not shown in the drawings. The obtained image 87 is then outputted from the consultation service terminal 7 to the consultation service support terminal 17 and from the consultation service support terminal 17 to the consultation service terminal 7 via the television conference server 5-7. Thereby, the consultation service terminal 7 and consultation service support terminal 17 can display the image shown in FIG. 17. The consultation service terminal 7 and consultation service support terminal 17 also obtain the voices of the customer or counselor and the supporter using a microphone not shown in the drawings and output the voices to each other. The consultation service terminal 7 and consultation service support terminal 17 output the voices obtained from each other through speakers not shown in the drawings. Thus the customer, counselor, and supporter can hold a conversation in a television conference format. Note that the consultation service terminal 7 and consultation service support terminal 17 may be constituted so as to output the image 87 to the shared server 5-1. In this case, the shared server 5-1 outputs to the consultation service terminal 7 an image in which the image 87 captured by the consultation service support terminal 17 is incorporated into the region 51 of the customer display unit 7A, and outputs to the consultation service support terminal 17 an image in which the image 87 captured by the consultation service terminal 7 is incorporated into the region 51 of the first display unit 17A.

Support through an execution of a shared application operation from the consultation service support terminal 17 is performed when the counselor presses the input control permission bar 82 of the consultation service terminal 7, for example. The consultation service support terminal 17 in its initial state (that is, when the input control permission bar 82 is not depressed) does not posses operating control rights, but by pressing the input control permission bar 82, operating control rights are transferred to the consultation service support terminal 17. As a result, the consultation service support terminal 17 becomes capable of operating the shared application. Note that if the input control permission bar 82 displayed on the first display unit 17A is depressed when operating control rights have not been transferred to the consultation service support terminal 17, the rights will not be transferred to the consultation service support terminal 17.

Support through an execution of a shared application operation from the consultation service support terminal 17 is performed when the supporter performs an operation on the shared application from the consultation service support terminal 17, for example. In this case, the shared server 5-1 creates an image indicating the results of the execution of the shared application in accordance with the operation on the consultation service support terminal 17, and outputs the created image to the consultation service terminal 7 and consultation service support terminal 17 such that an identical image is displayed on the consultation service terminal 7 and consultation service support terminal 17. This type of support also includes a case in which the supporter performs an operation from the consultation service support terminal 17 to cause printing to be executed. In this case, the shared server 5-1 drives a printer provided in the consultation service terminal 7 to execute printing.

Note that operating control rights are returned to the consultation service terminal 7 from the consultation service support terminal 17 when the counselor depresses the input control permission bar 82 displayed on the customer display unit 7A of the consultation service terminal 7 again, or when the supporter depresses the input control permission bar 82 displayed on the first display unit 17A of the consultation service support terminal 17 again.

(Interruption of Support—S7)

Next, it is assumed that support is interrupted. At this time, the counselor presses the input control permission bar 82 on the consultation service terminal 7 again. On the basis of this operation, the shared server 5-1 causes the consultation service support terminal 17 to forfeit operating control rights.

(End of Support—S8)

Next, it is assumed that support is complete. At this time, the counselor presses the connection bar 81 on the image 8B shown in FIG. 14 again. As a result, the screens of the customer display unit 7A and counselor display unit 7B of the consultation service terminal 7 do not change, but the screens of the first display unit 17A and second display unit 17B of the consultation service support terminal 17 return to their initial images (for example, the image shown in FIG. 15).

(End of Customer Contact—S9)

Next, it is assumed that the consultation with the customer is complete. At this time, the counselor presses the customer contact end bar 79 shown in FIG. 13. Note that the customer contact end bar 79 is a menu bar indicating the completion of contact with a customer. Operating control rights for ending a consultation are not provided to the consultation service support terminal 17. Hence even if the supporter presses the customer contact end bar 79 on the consultation service support terminal 17, the shared server 5-1 does not perform an operation to end the consultation.

When the customer contact end bar 79 on the consultation service terminal 7 is depressed, the shared server 5-1 closes the shared application operated from the consultation service terminal 7. At this time, the screens of the customer display unit 7A and counselor display unit 7B of the consultation service terminal 7 return to their initial states (for example, the images shown in FIGS. 9 and 10). If the consultation service support terminal 17 is connected, the screens of the first display unit 17A and second display unit 17B of the consultation service support terminal 17 also return to their initial states (for example, the image shown in FIG. 15).

The shared server 5-1 then outputs the operating history recorded throughout the progression of the consultation with the customer (for example, recorded data in the a forementioned prompter data format) to the DB server 5-3, and the operating history is recorded in the DB server 5-3.

According to the consultation service/support system 1 described above, when the counselor is unable to respond sufficiently to the consultation subject of the customer, the counselor may obtain data which correspond precisely to the consultation subject of the customer from the supporter operating the consultation service support terminal 17. Hence even a counselor with little knowledge or experience can respond appropriately to the consultation subject of the customer.

[Image Concealment Method]

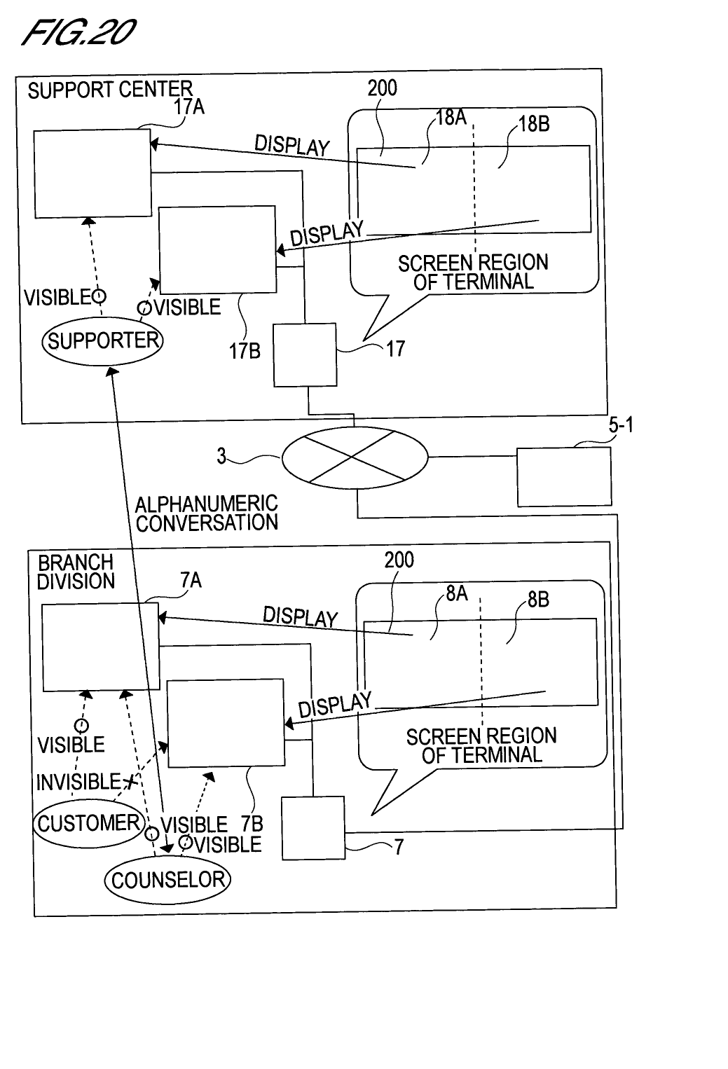

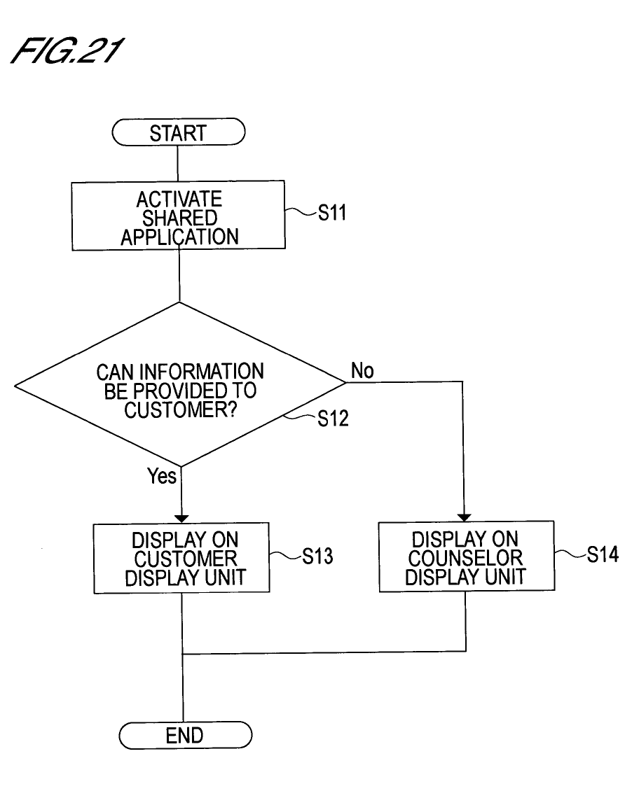

Among the images displayed on the customer display unit 7A and counselor display unit 7B, the display position of some images is limited to either the customer display unit 7A or the counselor display unit 7B. For example, images comprising highly confidential data or the like must be concealed from the customer. A method for providing the counselor with images comprising highly confidential data or the like such that these images are concealed from the customer will be described below. Note that below, images comprising highly confidential data or the like will be referred to as confidential images. In order to conceal a confidential image, measures must be taken regarding the disposal of the screen and the display position of the image. Screen disposal and image display position will be described below using FIGS. 20 and 21 respectively. FIG. 20 is a view showing an example of screen disposal, and FIG. 21 is a flowchart showing an example of shared server control.

(Screen Disposal)

In the consultation service/support system 1 according to the present invention, screens are disposed as shown in FIG. 20. More specifically, the consultation service terminal 7 is disposed such that customer display unit 7A can be viewed from the customer side and counselor side, and such that the counselor display unit 7B can be viewed from the counselor side but not from the customer side. Note that the consultation service support terminal 17 is disposed such that both the first display unit 17A and second display unit 17B can be viewed from the supporter side.

The image on the virtual screen 200 which is created by the shared server 5-1 comprises a customer image (that is, an image to be viewed by the customer) and a counselor image (that is, an image to be viewed by the counselor but concealed from the customer, or in other words an image including a confidential image). In the example shown in FIG. 7, for example, the image 201A in the region on the left side of the broken line is a customer image, and the image 201B in the region on the right side of the broken line is a counselor image. The shared server 5-1 outputs the image on the virtual screen 200 to the consultation service terminal 7 or the consultation service support terminal 17.

When the image on the virtual screen 200 is obtained from the shared server 5-1, the consultation service terminal 7 divides the image into the image 201A and the image 201B. The image 201A is then displayed on the customer display unit 7A as the customer image 8A, and the image 201B is displayed on the counselor display unit 7B as the counselor image 8B. As noted above, the customer display unit 7A is disposed to be viewed from both the customer side and counselor side, whereas the counselor display unit 7B is disposed to be viewed from the counselor side but not from the customer side. Hence the counselor is able to perform the consultation service while showing the customer appropriate data for the consultation subject of the customer and concealing confidential images.

Similarly to the consultation service terminal 7, the consultation service support terminal 17 comprises two display units (the first display unit 17A and second display unit 17B). When the image on the virtual screen 200 is obtained from the shared server 5-1, the consultation service support terminal 17 divides the image into the images 201A and 201B similarly to the consultation service terminal 7. The image 201A is then displayed on the first display unit 17A as the customer image 18A, and the image 201B is displayed on the second display unit 17B* as the counselor image 18B*. Thus the consultation service support terminal 17 is able to display the same image as the consultation service terminal 7 (or an image including a part of the image). Hence the supporter can grasp immediately the type of image that the counselor is viewing and the type of conversation that is being conducted with the customer, and as a result, appropriate support can be provided.

(Image Display Position)

Data limiting the display position (to be referred to as “display position limiting data” below) are attached to a confidential image. A judgment is made by a person in the main division 31 as to whether or not limitations should be placed on an image or data included in the image, and if it is judged that limitations should be placed thereon, the display position limiting data are attached to the image or data and recorded in a server (for example, the shared server 5-1, DB server 5-3, content server 5-5, channel server 5-6, and so on). When an image or data to which the display position limiting data are attached is found, the shared server 5-1 limits the display position of the image or data included in the image such that the image or data cannot be moved to the customer display unit 7A, for example.

The operations of the shared server 5-1 will be described in detail below using FIG. 21.

As shown in FIG. 21, first the shared server 5-1 activates the shared application in response to an operation from the consultation service terminal 7, and creates an image indicating the results of the execution of the shared application (S11). The shared server 5-1 then determines whether or not the image created in S11 may be provided to the customer (S12). In other words, the shared server 5-1 determines whether or not display position limiting data are attached to the image created in S11 or data included in the image. If the image may be provided (that is, if display position limiting data have not been attached to the image or data included in the image), the shared server 5-1 enables the image to be displayed on the customer display unit 7A (S13). If it is determined that the image may not be provided (that is, if display position limiting data have been attached to the image or data included in the image), the shared server 5-1 forbids the display of the image on the customer display unit 7A and limits display of the image to the counselor display unit 7B (S14).

In this manner, the shared server 5-1 is able to determine the display position of an image such that an image comprising highly confidential data or the like, for example, may be provided to the counselor but concealed from the customer.

Note that the system may be constituted such that limitations on the display position of an image and the removal thereof can be performed at will by an operation of the consultation service terminal 7. In this case, for example, the counselor can perform such a operation by specifying an image on which display position limitations are to be placed or removed using the pointing device not shown in the drawing, and then pressing a set bar 90 shown in FIGS. 7, 10 such that an operation to place or remove display position limitations is executed.

The present invention is not limited to the embodiment described above, and various applications and modifications within a scope which does not deviate from the gist of the present invention may be considered.

For example, the consultation service/support system according to the present invention is not limited to a financial institution, and may be used in a consultation service with a customer in a transportation system, distribution facility, and so on.

Further, the consultation service terminal may be a window device in the form disclosed in Japanese Unexamined Patent Application Publication 2001-112595, which was disclosed in the prior art. The consultation service terminal may also be in the form of a contract-creating device having a consultation service function, an automatic teller machine (ATM), or a transaction device for selling tickets, distributing music, or performing another function.

Further, the consultation service terminal 7 may be constituted with more than two display units. In this case, the number of display units in the consultation service support terminal 17 is preferably aligned with the number of display units in the consultation service terminal 7.

Further, the plurality of screens on the display units of the consultation service support terminal 17 may be integrated into a single screen.

The invention described above is effective in enabling a consultation service to progress smoothly at all times.

What is claimed is:

1. A consultation service/support system comprising:
a consultation service terminal comprising a customer display, which is disposed so as to be viewable from a customer side and a counselor side on a service provider side, for displaying screens to a customer, and a counselor display, which is disposed so as to be viewable from the counselor side but not from the customer side, for displaying screens that are to be concealed from the customer, said terminal being constituted in a consultative interactive form allowing face-to-face dialogue between the customer and counselor such that a consultation service with the customer is performed while the customer and counselor converse through the display on said customer display of appropriate screens for the consultation subject of the customer; and
a consultation service support terminal for supporting the consultation service with the customer by outputting data for assisting the consultation service with the customer.

2. The consultation service/support system according to claim 1, further comprising a server which is connected to said consultation service terminal and said consultation service support terminal via a communication network, which stores an application that can be operated by both said consultation service terminal and said consultation service support terminal, and which executes said application on the basis of an operation performed on said consultation service terminal or said consultation service support terminal,
wherein said consultation service terminal and said consultation service support terminal obtain from said server a screen indicating the result of an execution of said application by said server, and display said screen.

3. A consultation service terminal comprising a customer display, which is disposed so as to be viewable from a customer side and a counselor side on a service provider side, for displaying screens to a customer, and a counselor display, which is disposed so as to be viewable from the counselor side but not from the customer side, for displaying screens that are to be concealed from the customer, said terminal being constituted in a consultative interactive form allowing face-to-face dialogue between the customer and counselor such that while the customer and counselor converse, appropriate screens for the consultation subject of the customer can be displayed on said customer display, and data for assisting the consultation service with the customer, outputted by a consultation service support terminal for supporting the consultation service with the customer, can be displayed on said counselor display.

4. The consultation service terminal according to claim 3, wherein said data for assisting the consultation service with the customer are alphanumeric data, and are transmitted from and received by said consultation service support terminal and displayed on said counselor display.

5. The consultation service terminal according to claim 3, wherein the display position of a region for displaying specific data can be limited to a position within a screen which is concealed from said customer.

6. A server which stores an application that can be operated by a consultation service terminal for performing a consultation service with a customer, and which executes said application on the basis of an operation performed on said consultation service terminal to create a screen indicating the result of this execution, whereupon said screen is outputted to said consultation service terminal.

7. The server according to claim 6, wherein the created screen is outputted to said consultation service terminal after being divided into a screen to be provided to the customer and a screen to be concealed from the customer.

8. The server according to claim 7, wherein the display position of a region for displaying specific data can be limited to a position within a screen which is concealed from said customer.

9. A computer-readable medium having software for performing, on a computer comprising a customer display which is disposed so as to be viewable from a customer side and a counselor side on a service provider side for displaying screens to a customer, and a counselor display which is disposed so as to be viewable from the counselor side but not from the customer side for displaying screens that are to be concealed from the customer, said computer being constituted in a consultative interactive form allowing face-to-face dialogue between the customer and counselor, a method of displaying on said customer display appropriate screens for the consultation subject of the customer, and displaying on said counselor display data for assisting the consultation service with the customer which are outputted by a consultation service support terminal for supporting the consultation service with the customer.

10. A computer-readable medium having software for performing, on a computer which is connected to a consultation service terminal for performing a consultation service with a customer and which stores an application that can be operated by said consultation service terminal, a method of executing said application on the basis of an operation performed on said consultation service terminal to create a screen indicating the result of this execution, and outputting said screen to said consultation service terminal.
